(19) United States
(12) Patent Application Publication
(10) Pub. No.: US 2013/0093946 A1
(43) Pub. Date: Apr. 18, 2013

(54) DISPLAY APPARATUS

(71) Applicant: Keita Nakagawa, Tokyo (JP)

(72) Inventor: Keita Nakagawa, Tokyo (JP)

(73) Assignee: Sony Corporation, Tokyo (JP)

(21) Appl. No.: 13/598,993

(22) Filed: Aug. 30, 2012

(30) Foreign Application Priority Data
Oct. 18, 2011 (JP) 2011-229170

(51) Int. Cl. H04N 5/225

(52) U.S. Cl. 348/374; 348/E05.025

(57) ABSTRACT

A display apparatus in which the angle of a display section can be varied freely. The display apparatus includes the display section and arms. The arms connect the display section with an attachment target to which the display section is to be attached in such a manner that inclination angles of the arms with respect to the display section or the attachment target can be changed independently of one another. The number of the arms is a multiple of four.

### BACKGROUND

The present disclosure relates to a display apparatus in which the angle of a display section can be varied.

There has been proposed use of a hinge mechanism to allow a monitor device or display section incorporated in a video camera apparatus to rotate in upward and downward directions, as disclosed in Japanese Patent Laid-open No. Hei 8-98068, for example.

### SUMMARY

However, with such configuration, it is difficult to move the display section in all directions over 360 degrees. In this regard, the configuration still has a room for improvement.

Therefore, it is desirable to provide a display apparatus including a display section whose angle can be varied freely.

One embodiment of the present technology is a display apparatus including the following two constituent elements (A) and (B):

(A) Display section;
(B) Arms connecting the display section with an attachment target to which the display section is to be attached in such a manner that inclination angles of the arms with respect to the display section or the attachment target can be changed independently of each other, the number of arms being a multiple of four.

In the display apparatus, the display section and the attachment target of the display section are connected by a multiple of four arms in such a manner that the inclination angles of the arms with respect to the display section or the attachment target can be changed independently of each other. Therefore, the angle of the display section can be changed freely.

The above and other features and advantages of the present disclosure will become apparent from the following description, accompanying drawings and the appended claims.

### BRIEF DESCRIPTION OF THE DRAWINGS

FIG. 1 is a perspective view showing an outer appearance of an image pickup apparatus including a display apparatus according to one embodiment of the present technology;

FIG. 2 is a perspective view of the display apparatus shown in FIG. 1 showing a configuration of the rear side of the display section as viewed from above where the upper side of the display section is leaned rearward;

FIG. 3 is a perspective view showing a configuration of arms shown in FIG. 2;

FIG. 4 is an exploded perspective view illustrating connection between the arms and the display section shown in FIG. 2;

FIG. 5 is an exploded perspective view illustrating connection between the arms and a main body section shown in FIG. 2;

FIG. 6 is an enlarged sectional view illustrating a fixed state of a rubber washer shown in FIG. 5;

FIGS. 7A to 7C are schematic views illustrating changes in the inclination angle of one arm shown in FIG. 2 with respect to the main body section;

FIG. 8 is a view illustrating the positions of second movable joining portions in FIG. 1;

FIG. 9 is a perspective view illustrating a state of the display section at a high angle in a horizontal position;

FIG. 10 is a schematic view illustrating the positions of the second movable joining portions in FIG. 9;

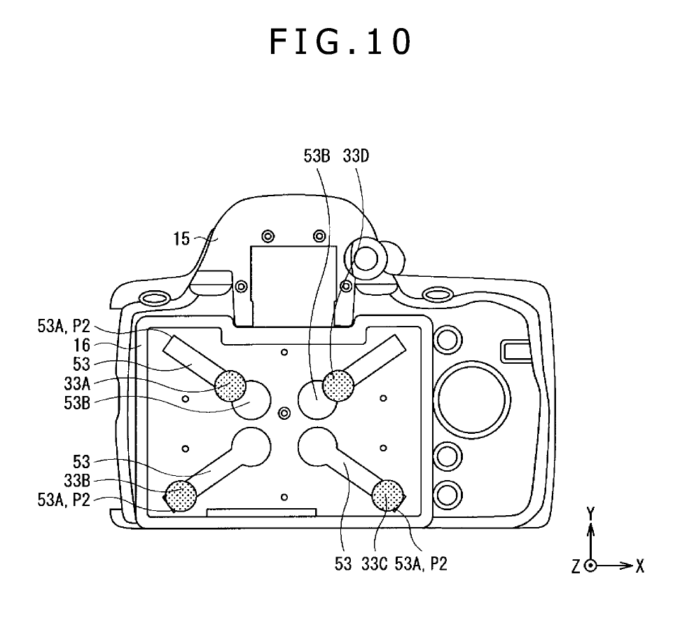

FIG. 11 is a perspective view illustrating a state of the display section at a low angle in a horizontal position;

FIG. 12 is a schematic view illustrating the positions of the second movable joining portions in FIG. 11;

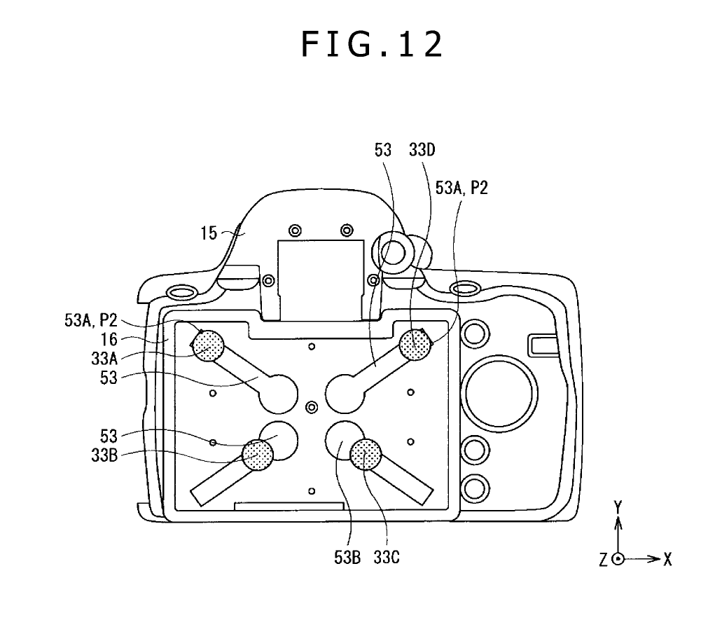

FIG. 13 is a perspective view illustrating a state of the display section at a high angle in a vertical position;

FIG. 14 is a schematic view illustrating the positions of the second movable joining portions in FIG. 13;

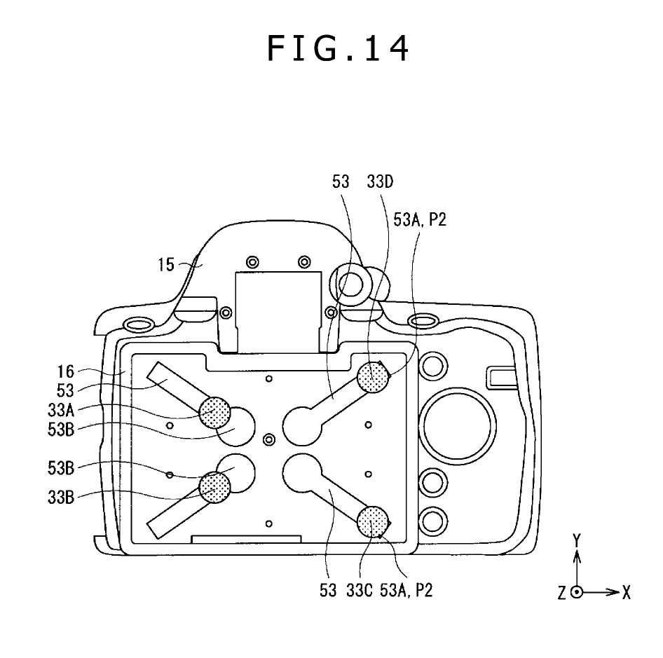

FIG. 15 is a perspective view illustrating a state of the display section at a low angle in a vertical position;

FIG. 16 is a schematic view illustrating the positions of the second movable joining portions in FIG. 15;

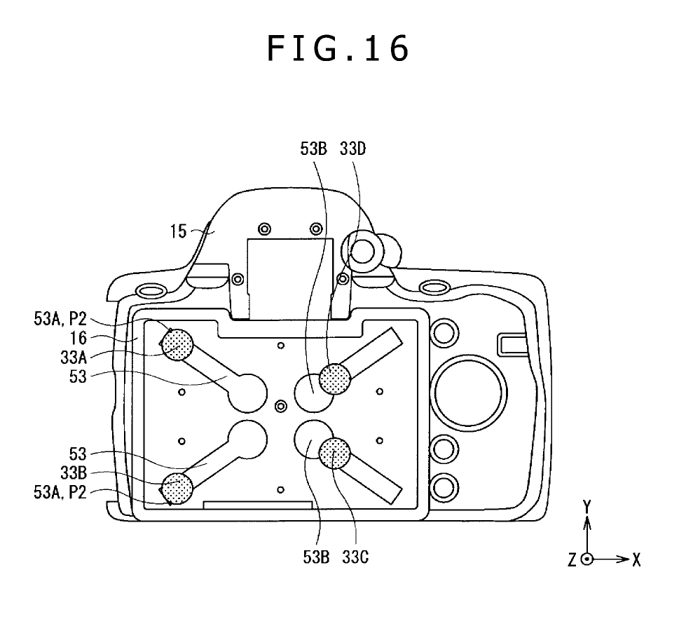

FIG. 17 is a perspective view of the image pickup apparatus in a state in which the display section is set obliquely;

FIG. 18 is a schematic view illustrating the positions of the second movable joining portions in FIG. 17;

FIGS. 19A and 19B are perspective views illustrating operation for changing the position of the display section from horizontal position-high angle to vertical position-high angle;

FIGS. 20A and 20B are perspective views illustrating operation for changing the position of the display section from vertical position-low angle to horizontal position-low angle;

FIG. 21 is a perspective view illustrating operation for changing the angle of a display section of an image pickup apparatus in the past;

FIG. 22 is a perspective view illustrating the image pickup apparatus of FIG. 1 with a vertical position control grip attached thereto;

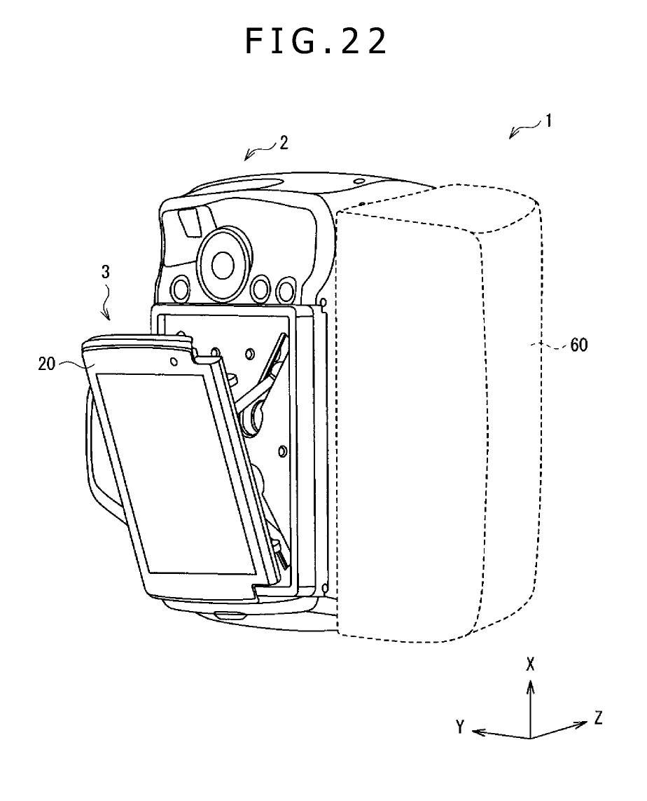

FIG. 23 is a perspective view illustrating interference between the display section and a vertical position control grip in the image pickup apparatus of a related art; and

FIG. 24 is a plan view showing an example of guide grooves in the case where eight arms are provided.

### DETAILED DESCRIPTION OF THE PREFERRED EMBODIMENT

In the following, an embodiment of the disclosed technology is described in detail with reference to the accompanying drawings.

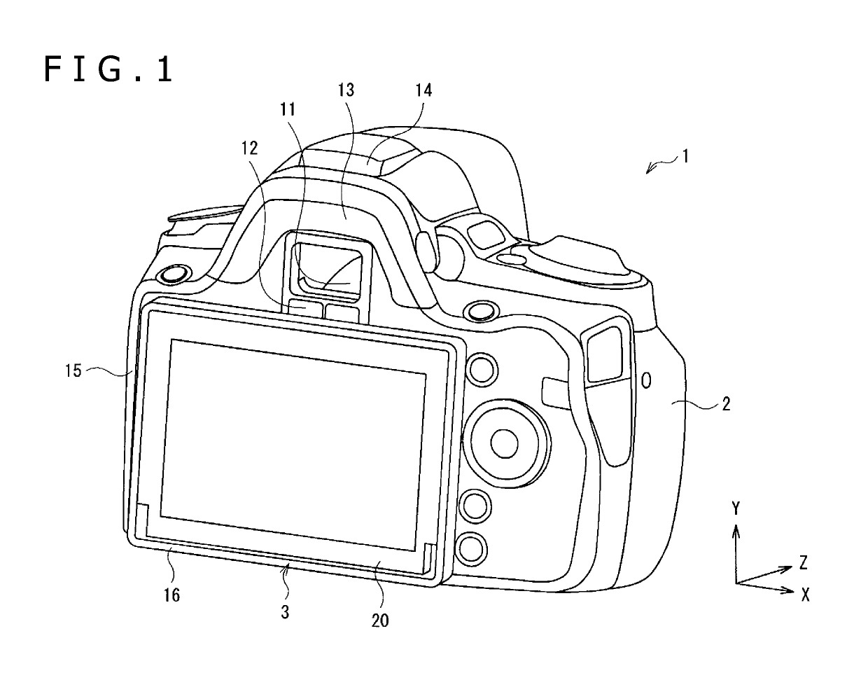

FIG. 1 shows a configuration of an image pickup apparatus, here a digital single lens reflect camera, including a display apparatus according to one embodiment of the present disclosure, as viewed from the rear face side. Referring to FIG. 1, the image pickup apparatus 1 includes a display apparatus 3 provided, for example, on the rear face of a main body section 2. It is to be noted that, in the drawings, the direction of the optical axis, i.e., the forward and rearward direction of the camera, is referred to and represented as z direction; the horizontal direction, i.e., the leftward and rightward direction of the camera as x direction; and the vertical direction, i.e., the upward and downward direction of the camera as y direction.

The main body section 2 has an image pickup lens not shown on the front face thereof, and at an upper position on the rear face, a viewfinder 11, an eye sensor 12, and an eye hood 13 surrounding the viewfinder 11 and the eye sensor 12. The eye hood 13 may be removable. An accessory shoe 14 for attaching an accessory such as a flash light emitting device is provided on the upper face of the main body section 2. The main body section 2 records an image picked up through the image pickup lens not shown into or on a recording medium such as, for example, a built-in memory or hard disk, or a memory or hard disk inserted in a slot for an external device.

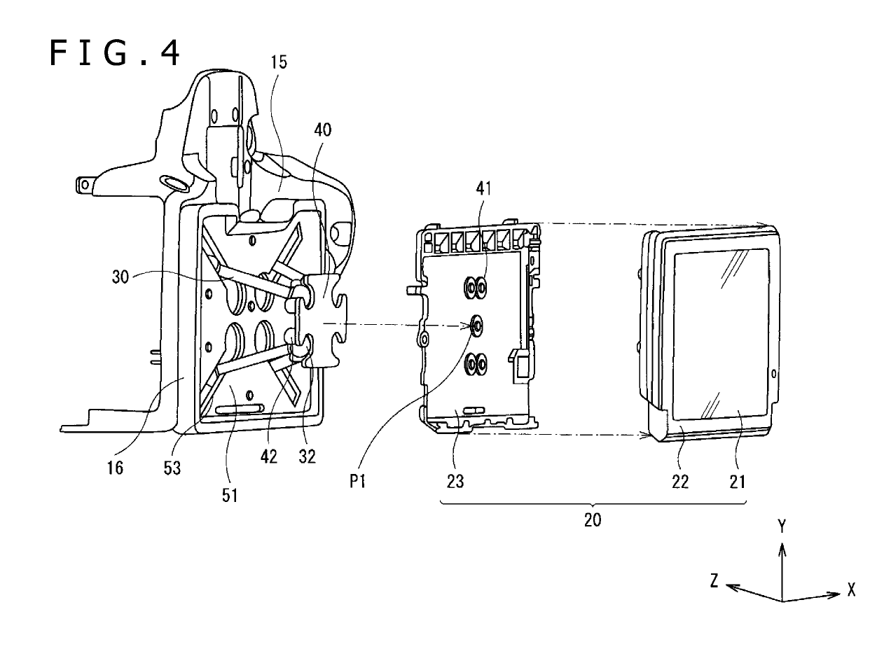

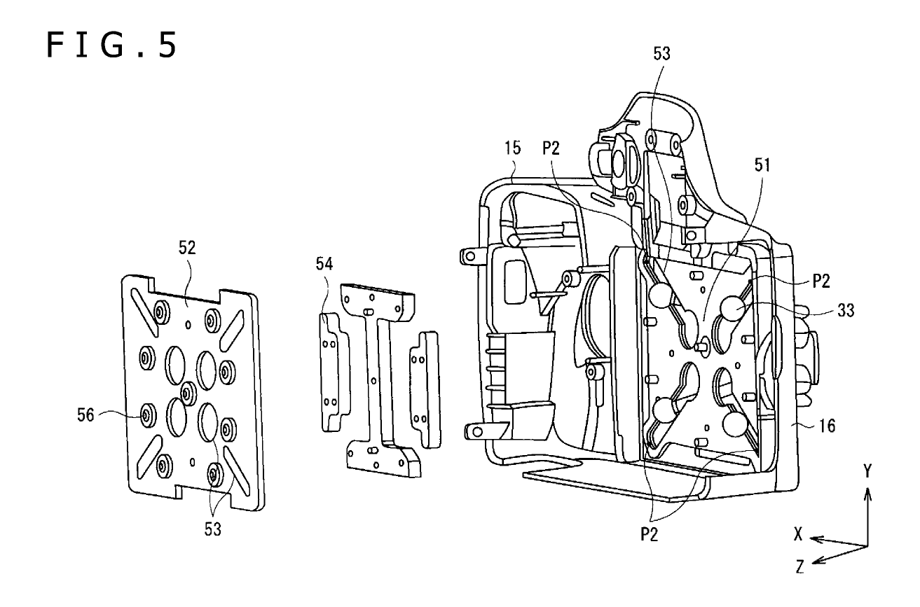

The back face of the main body section 2 is covered with a rear exterior member or rear cover 15 (refer to FIGS. 4 and 5). An accommodating section 16 for accommodating a display section 20 of the display apparatus 3 described later is provided in an area inside the rear exterior member 15 below the viewfinder 11. The accommodating section 16 has a rectangular shape with dimensions substantially same as those of the display section 20, and it may also have a concave and convex shape provided thereon in accordance with the shape of the display apparatus 3 as demanded.

The display apparatus 3 displays an image picked up by the image pickup lens not shown, and it has the rectangular display section 20 formed, for example, from a liquid crystal display panel. The display section 20 can be accommodated into the accommodating section 16 in such a state that it forms part of the rear face of the main body section 2 as seen in FIG. 1. It is to be noted that the display section 20 is connected to the main body section 2 by a flexible printed circuit (FPC) or a like member not shown.

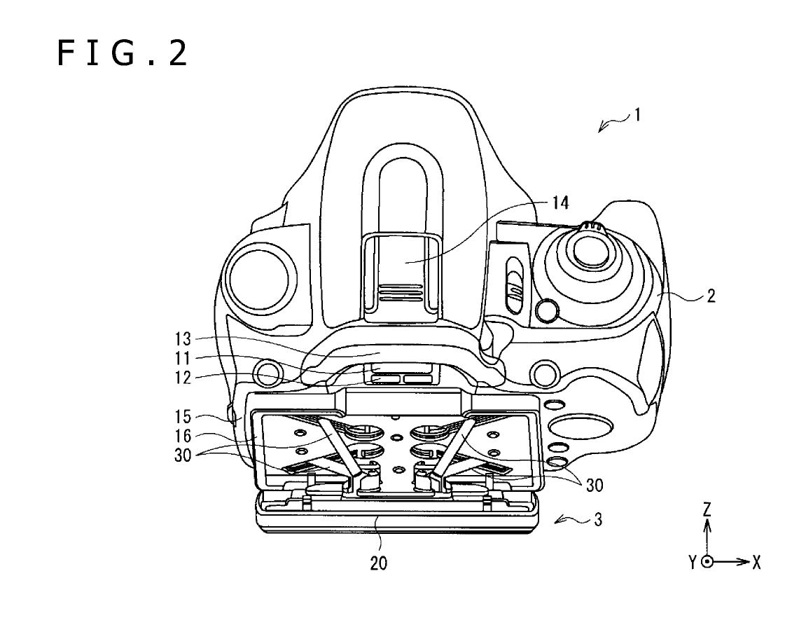

FIG. 2 shows a configuration of the display section 20 when the rear side of the display section 20 is viewed from above with the upper side of the display section 20 leaned backward. A plurality of, four in FIG. 2, arms 30 are provided on the rear side of the display section 20. The arms 30 connect the display section 20 with the main body section 2, which is the attachment target of the display section 20, in such a manner that the inclination angles thereof with respect to the main body section 2 can be varied independently of each other. Consequently, the position of the display section 20 can be varied freely.

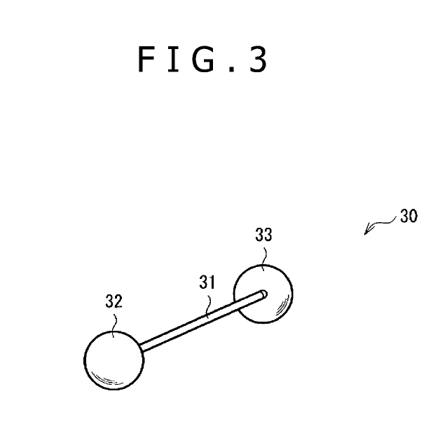

FIG. 3 shows a configuration of one of the arms 30. Each arm 30 has a stem portion 31, and a first movable joining portion 32 and a second movable joining portion 33 provided at the opposite ends of the stem portion 31. The stem portion 31 has a form of, for example, a bar having a linear shape with a fixed thickness while the cross sectional shape thereof is not limited particularly. Preferably, the first movable joining portion 32 and the second movable joining portion 33 particularly have, for example, a spherical shape. This is because if the first movable joining portion 32 and the second movable joining portion 33 have a spherical shape, the arm 30 can be moved in various directions. Incidentally, the spheres of the first movable joining portion 32 and the second movable joining portion 33 naturally have a diameter greater than that of the stem portion 31.

The arms 30 are made of, for example, a metal or a resin. As the resin, an ABS resin, i.e., an acrylonitrile-butadiene-styrene resin, or a PC resin, i.e., a polycarbonate resin, and so forth are applicable. Specifically, an ABS resin having a high sliding performance is used preferably.

FIG. 4 shows a configuration of portions of the arms 30 shown in FIG. 2 on the outer side with respect to the main body section 2. Referring to FIG. 4, the display section 20 is configured such that a liquid crystal cell 21 is sandwiched between a front side covering member 22 and a back side covering member 23. The arms 30 are provided between the back side covering member 23 of the display section 20 and the accommodating section 16 of the rear exterior member 15 of the main body section 2. The first movable joining portions 32 of the arms 30 are disposed in a concentrated manner at a first specific position P1 of the display section 20 which is, for example, the center of the display section 20, that is, the intersection of the diagonal lines of the main body section 2. The second movable joining portions 33 are movable in radial directions in the xy plane along the diagonal lines of the accommodating section 16 from second specific positions P2 of the accommodating section 16 of the main body section 2, for example, from the four corners of the accommodating section 16, toward the center of the accommodating section 16, that is, toward the intersection of the diagonal lines of the accommodating section 16. It is to be noted that the first specific position P1 is a region which includes not only one point at the center of the display section 20 but also a neighboring area around the point. Meanwhile, the second specific positions P2 are regions which include not only points at the four corners of the accommodating section 16 but also neighboring areas around the points.

The first movable joining portions 32 are attached to the display section 20 such that they can rotate with respect to the display section 20. In particular, at the first specific position P1 of the back side covering member 23 of the display section 20, an arm holder 40 is fixed with a screw not shown with a rubber washer 41 disposed therebetween. The arm holder 40 has holders 42 for accommodating the first movable joining portions 32 in a rotatable manner. The number of such holders 42 is equal to the number of the arms 30, for example, four holders 42 are provided for four arms 30, so that one first movable joining portion 32 is held by one holder 42 in a manner that it can rotate 360 degrees. The rubber washer 41 is provided to adjust the sandwiching force, which in turn allows fine adjustment of the sliding force of the first movable joining portion 32.

FIG. 5 shows a configuration of portions of the arms 30 shown in FIG. 2 on the inner side with respect to the main body section 2. Referring to FIG. 5, each of the second movable joining portions 33 is attached to the main body section 2 in such a manner that they can move within the xy plane. In particular, the second movable joining portions 33 are sandwiched between a pair of plates 51 and 52 fixed to the accommodating section 16 of the main body section 2, such that they can move along guide slots 53 provided in the plates 51 and 52. Such guide slots 53 are provided radially from the second specific positions P2 of the accommodating section 16 of the main body section 2 toward the center of the accommodating section 16 along the diagonal lines of the accommodating section 16.

The plate 51, which is the one positioned on the outer side between the plates 51 and 52, serves as the bottom face of the accommodating section 16 of the rear exterior member 15, and it also functions as a reinforcing plate for the accommodating section 16. The inner side plate 52 functions as a holding plate for supporting the second movable joining portions 33 from the inner side of the main body section 2. The guide slots 53 may be provided in both of the plates 51 and 52 or only on the outer side plate 51.

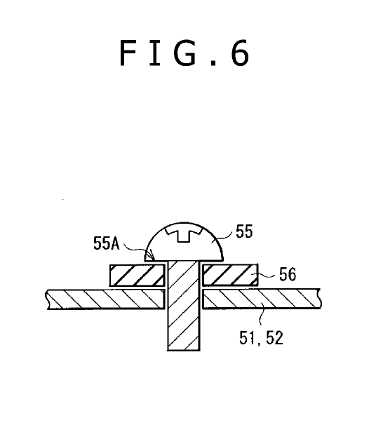

The plates 51 and 52 are fixed by screws 55 not shown in FIG. 5 but shown in FIG. 6 with spacers 54 interposed therebetween. Preferably, a rubber washer 56 is provided between a seat face 55A of each screw 55 and the plates 51 and 52 as seen in FIG. 6. The rubber washer 56 allows adjustment of the sandwiching force of the second movable joining portion 33, whereby the sliding force of the second movable joining portions 33 can be finely adjusted.

In the image pickup apparatus 1 including the display apparatus 3 described above, the inclination angle of the display section 20, that is, the orientation of the screen of the display section 20, can be varied freely by individually varying the inclination angle of the four arms 30 with respect to the main body section 2.

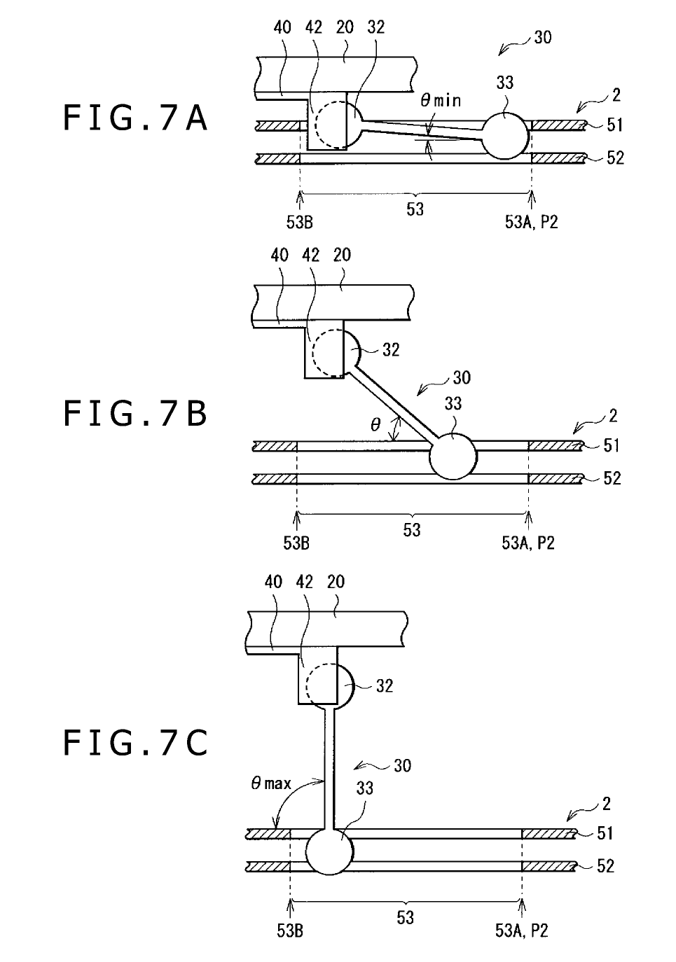

In particular, it is possible to arbitrarily change the inclination angle of each arm 30 with respect to the main body section 2 from substantially 0 degrees, i.e., a parallel state, to substantially 90 degrees, i.e., a perpendicular state, by moving the second movable joining portion 33 of the arm 30 within the corresponding guide slot 53. To be more specific, as seen in FIG. 7A, when the second movable joining portion 33 of the arm 30 is at the second specific position P2, that is, at an outer side end 53A of the guide slot 53, the first movable joining portion 32 is positioned at an inner side end 53B of the guide slot 53, and the inclination angle θ of the arm 30 with respect to the main body section 2 is a minimum angle θmin which is substantially 0 degrees. As the second movable joining portion 33 moves inward toward the center of the accommodating section 16 along the guide slot 53 as seen in FIG. 7B, the inclination angle θ of the arm 30 with respect to the main body section 2 increases. When the second movable joining portion 33 is at the inner side end 53B of the guide slot 53 as seen in FIG. 7C, the inclination angle θ is a maximum angle θmax which is substantially 90 degrees. Adjusting the inclination angles θ of all of the arms 30 with respect to the main body section 2 independently from each other, the inclination angle of the display section 20 is arbitrarily changed over 360 degrees upward and downward and 360 degrees leftward and rightward.

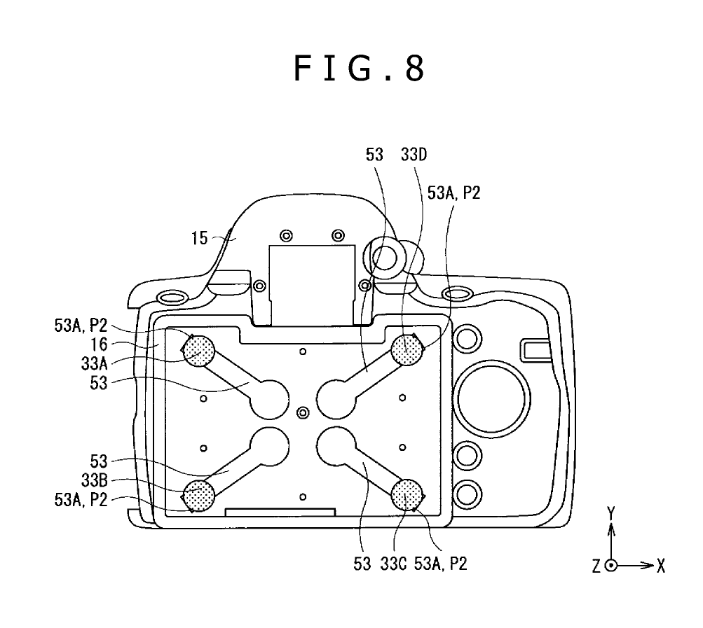

For example, in a state in which the display section 20 is accommodated in the accommodating section 16 as in FIG. 1, as seen in FIG. 8, the second movable joining portions 33 (33A to 33D) of the four arms 30 are positioned at the second specific positions P2, that is, at the outer side ends 53A of the guide slots 53. In other words, the inclination angles θ of the four arms 30 are all at the minimum angle θmin which is substantially 0 degrees. In such a state in which the display section 20 is accommodated in the accommodating section 16, the arms 30 are completely hidden in the rear side of the display section 20 and cannot be observed from the outside. This allows the appearance of the image pickup apparatus 1 to be improved. In addition, the arms 30 do not press the arrangement space for operation members on the rear face of the main body section 2.

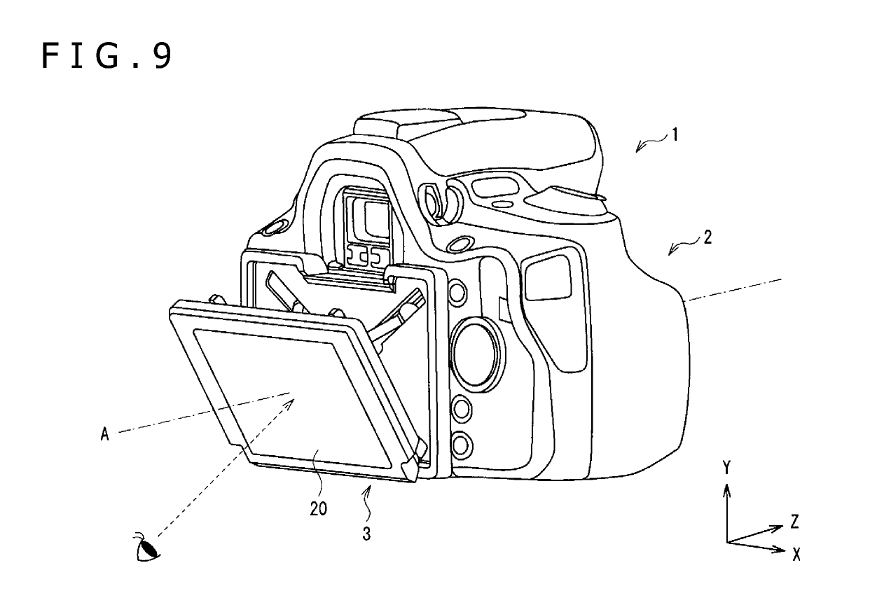

Here, if it is desired to shoot a picture at a high angle in a horizontal position, that is, by such a photographing method that the image pickup apparatus 1 is held at a high position, for example, above the head with the longitudinal side thereof extending in the horizontal direction, the main body section 2 is held horizontally and the upper side of the display section 20 is leaned towards the user's side, as seen in FIG. 9. Consequently, the second movable joining portions 33A and 33D of the two arms 30 on the upper side of the display section 20 move along the corresponding guide slots 53 to the inner side ends 53B. The second movable joining portions 33B and 33C of the two arms 30 on the lower side of the display section 20 remain at the outer side ends 53A of the guide slots 53.

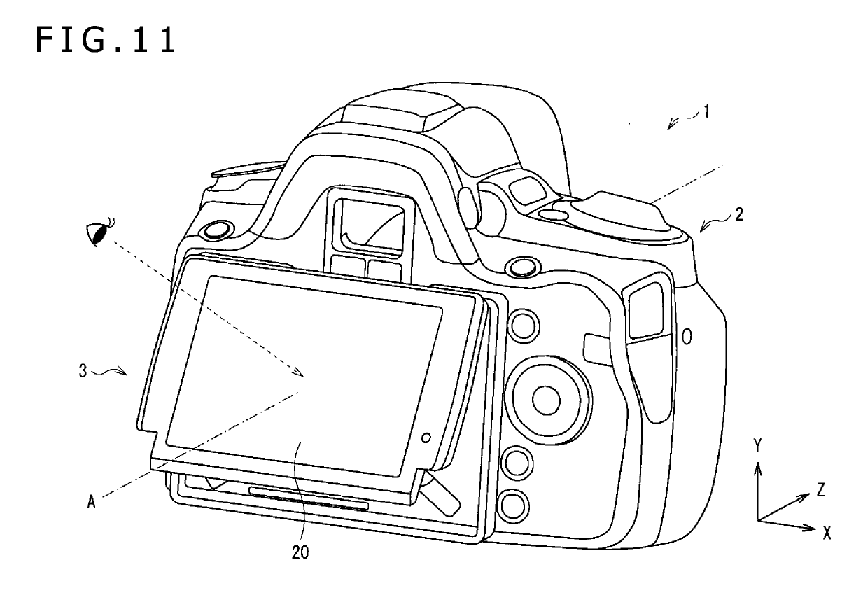

On the other hand, if it is desired to take a picture at a low angle in a horizontal position, that is, by such a photographing method that the image pickup apparatus 1 is held at a low position, for example, around the belly with the longitudinal side thereof extending in the horizontal direction, the lower side of the display section 20 is pulled toward the user's side while the upper side thereof is pressed toward the main body section 2 side, as seen in FIG. 11. Consequently, the second movable joining portions 33A and 33D of the two arms 30 on the upper side of the display section 20 move along the corresponding guide slots 53 to the second specific positions P2, that is, to the outer side ends 53A. Meanwhile, the second movable joining portions 33B and 33C of the two arms 30 on the lower side of the display section 20 move along the corresponding guide slots 53 to the inner side ends 53B.

It is not to mention that the display section 20 can be tilted to an arbitrary angle between the horizontal position-high angle illustrated in FIG. 9 and the horizontal position-low angle illustrated in FIG. 11 (horizontal position tilting).

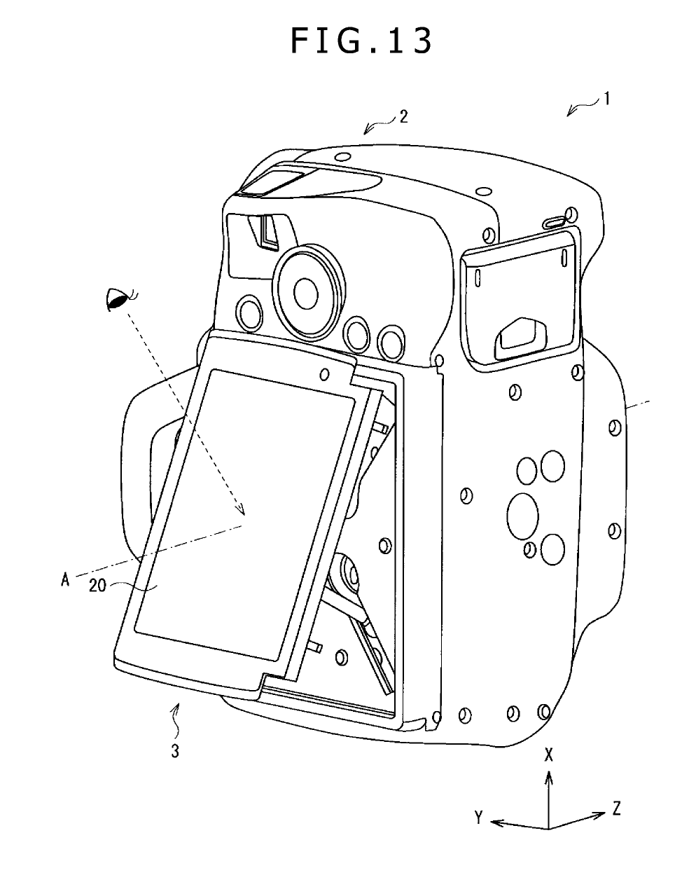

If it is desired to take a picture at a low angle with the image pickup apparatus 1 in a vertical position, that is, by such a shooting method that the image pickup apparatus 1 is held at a low position, for example, around the belly with the longitudinal side thereof extending vertically, the main body section 2 is held vertically and the left side of the display section 20 is pulled toward the user's side while the right side thereof is pressed toward the main body section 2 side, as seen in FIG. 13. Consequently, the second movable joining portions 33C and 33D of the two arms 30 on the right side of the display section 20 move along the corresponding guide slots 53 to the second specific positions P2, that is, to the outer side ends 53A. Meanwhile, the second movable joining portions 33A and 33B of the two arms 30 on the left side of the display section 20 move along the corresponding guide slots 53 to the inner side ends 53B.

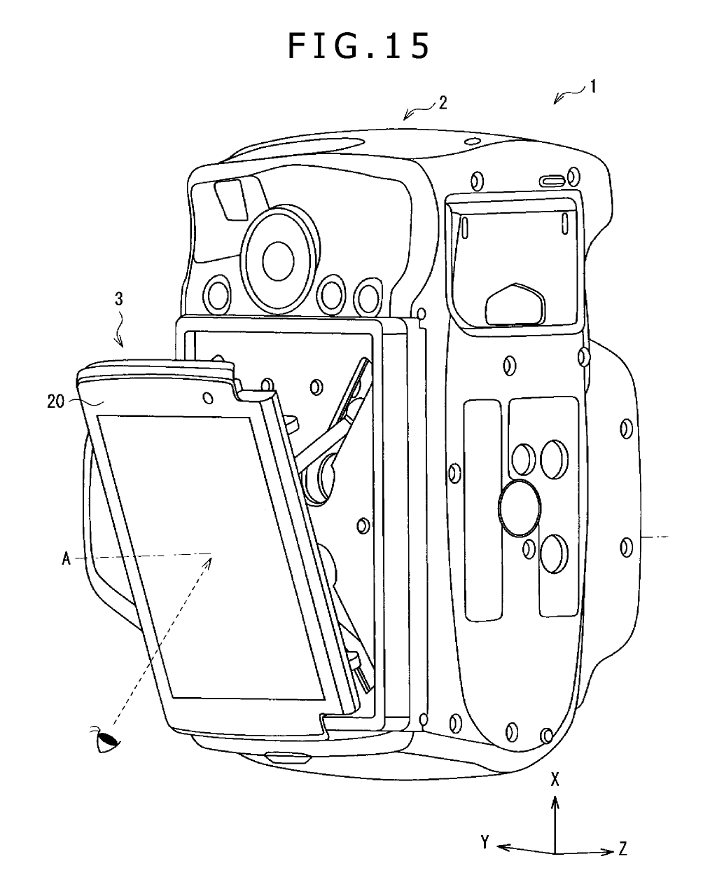

On the other hand, if it is desired to take a picture at a high angle with the image pickup apparatus 1 in a vertical position, that is, by such a shooting method that the image pickup apparatus 1 is held at a high position, for example, above the head with the longitudinal side thereof extending vertically, the main body section 2 is held vertically and the right side of the display section 20 is pulled toward the user's side while the left side thereof is pressed toward the main body section 2 side, as seen in FIG. 15. Consequently, the second movable joining portions 33A and 33B of the two arms 30 on the left side of the display section 20 move along the corresponding guide slots 53 to the second specific positions P2, that is, to the outer side ends 53A. Meanwhile, the second movable joining portions 33C and 33D of the two arms 30 on the right side of the display section 20 move along the corresponding guide slots 53 to the inner side ends 53B.

It is to be noted that naturally the display section 20 can be tilted to an arbitrary angle between the vertical position-low angle illustrated in FIG. 13 and the vertical position-high angle illustrated in FIG. 15 (vertical position tilting).

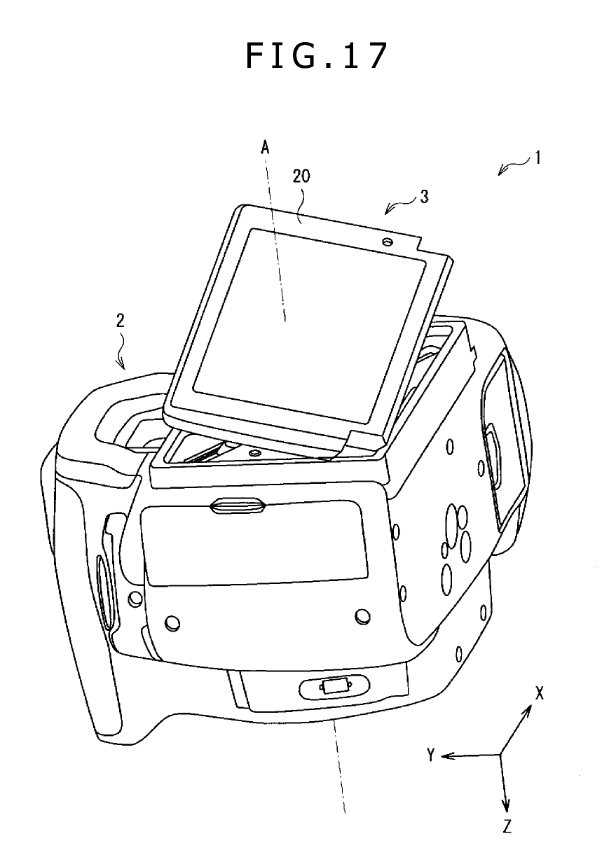

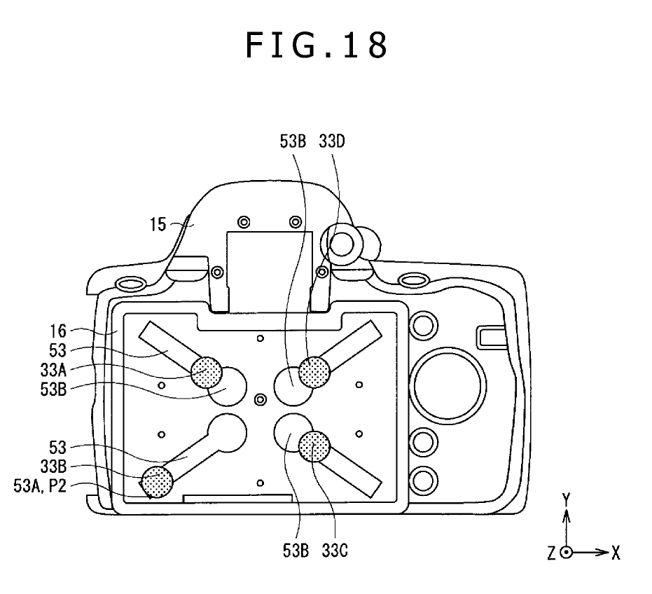

Further, either in the vertical position or horizontal position, it is possible to take a picture setting the display section 20 obliquely as seen in FIG. 17. For example, the right higher corner of the display section 20 is pulled toward the user's side while the left lower corner of the display section 20 is pressed toward the main body section 2 side. Consequently, as seen in FIG. 18, the second movable joining portion 33B of the left lower arm 30 of the display section 20 moves along the corresponding guide slot 53 and returns to the second specific position P2, that is, to the outer side end 53A. Meanwhile, the second movable joining portions 33A, 33C and 33D of the remaining three arms 30 move along the corresponding guide slots 53 and come to the inner side ends 53B. It is not to mention that, while FIG. 17 illustrates a state in which the display section 20 is oriented obliquely leftward and downward as an example, the display section 20 can also be oriented obliquely leftward and upward, obliquely rightward and upward and obliquely rightward and downward.

Since the range of movement of the display section 20 is restricted by the four arms 30 as seen in FIGS. 9, 11, 13, 15 and 17, it is substantially contained in a space just above the accommodating section 16 and does not protrude much therefrom. Therefore, vertical position tilting and horizontal position tilting can be carried out in the proximity of the optical axis A of the image pickup lens not shown. The deviation of the center of the display section 20 from the optical axis A, that is, the center of the image pickup lens can be reduced, whereby the user can carry out shooting in a natural posture holding the image pickup apparatus 1 in front.

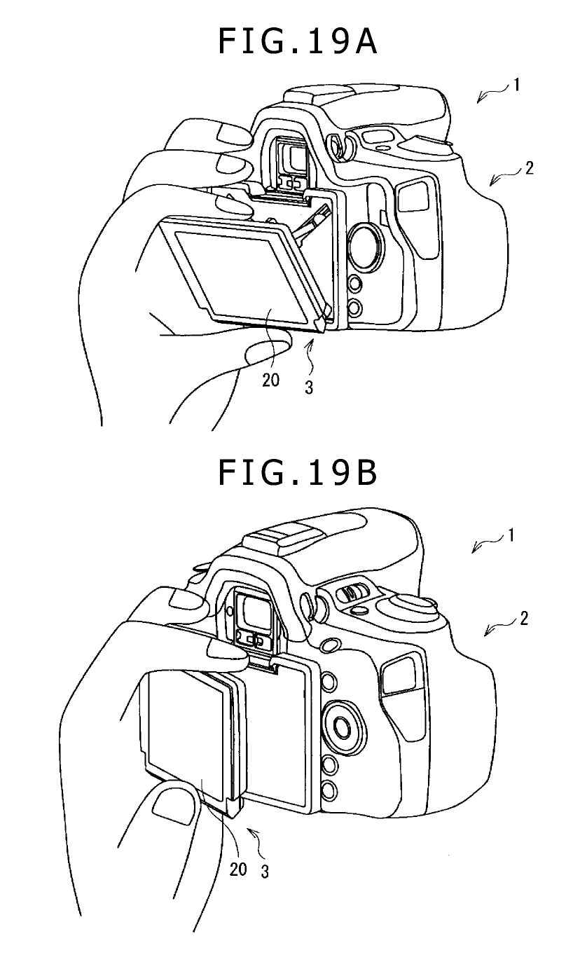

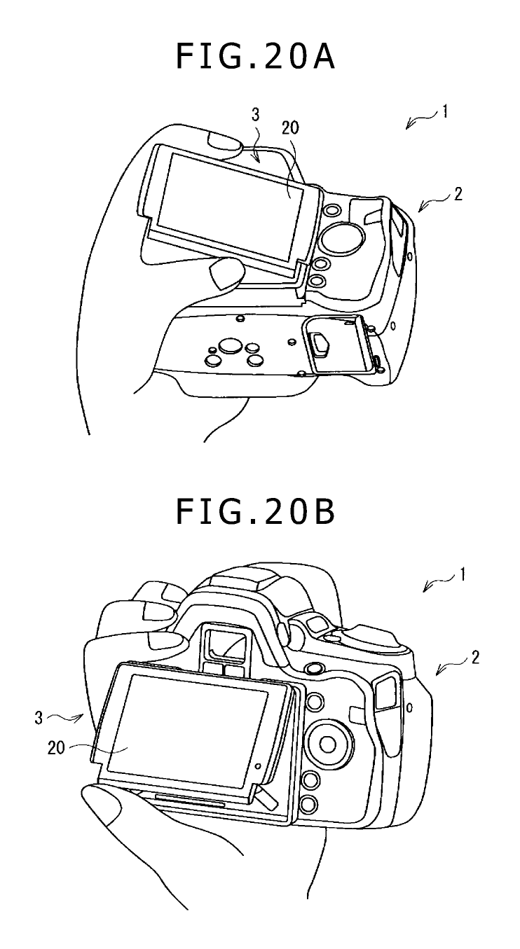

When it is desired to change the direction of the display section 20, it can be shifted immediately to the desired state without passing through a different state. For example, if it is desired to change the direction of the display section 20 from the horizontal position-high angle to the vertical position-high angle, it is only necessary to put the thumb and forefinger on the lower side and the upper side of the display section 20 as shown in FIG. 19A, and then pull out the right side of the display section 20 to the user's side with the two fingers as seen in FIG. 19B. Similarly, when it is desired to change the direction of the display section 20 from the vertical position-low angle to the horizontal position-low angle, it is only necessary to put the thumb and forefinger on the lower side and the upper side of the display section 20 as shown in FIG. 20A, and then push out the lower side of the display section 20 with the thumb while holding the upper side of the display section 20 with the forefinger, as seen in FIG. 20B.

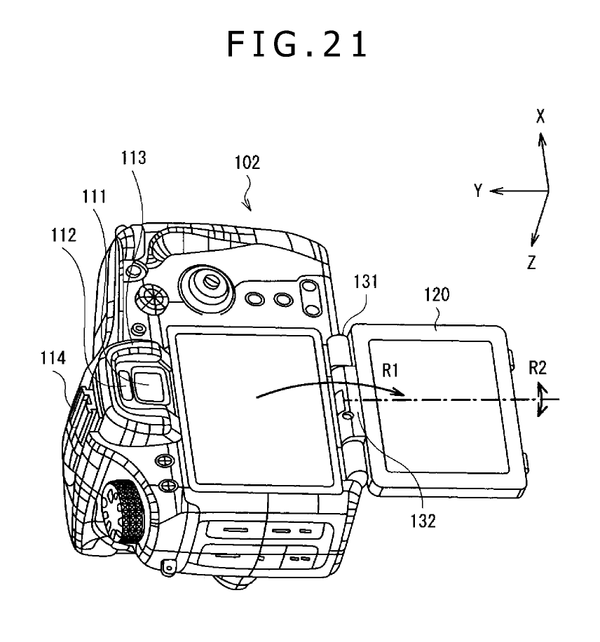

In contrast, in related arts, as illustrated in FIG. 21 as an example, an opening/closing hinge mechanism 131 and a rotating hinge mechanism 132 are provided on the lower side of the rear face of a main body section 102 so as to change the inclination angle of a display section 120. In particular, the display section 120 is first opened in the direction indicated by an arrow R1 with the opening/closing hinge mechanism 131, and then the display section 120 is rotated in the direction indicated by an arrow R2 with the rotating hinge mechanism 132. In contrast, in the present embodiment, such two steps of operation are not required. That is to say, in the present embodiment, operations unnecessary for shooting such as unfolding, folding, and rotating the display section 20 can be eliminated. Further, the display section 20 can be moved at will without stress, and consequently, the comfortability of use for the user is improved.

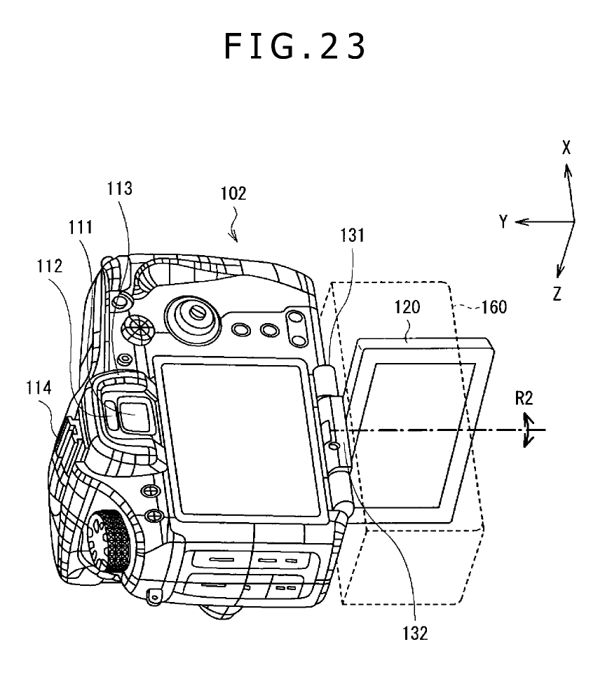

Further, with the present embodiment, the inclination angle of the display section 20 can be changed freely even when a vertical position control grip 60 is attached, and particularly the convenience of when a picture is taken in the vertical position is improved. In this regard, in the related arts as the one described hereinabove, when the display section 120 is rotated in the direction indicated by the arrow R2 with the rotating hinge mechanism 132 as illustrated in FIG. 23, the display section 120 and a vertical position control grip 160 interfere with each other. Therefore, it was difficult to attach the vertical position control grip 160.

In the present embodiment, the display section 20 and the main body section 2, to which the display section 20 is attached, are connected to each other by the four arms 30. The arms 30 are configured such that the inclination angles thereof with respect to the main body section 2 can be changed independently from one another. Therefore, the inclination angle of the display section 20 can be changed freely.

While the present disclosure is described above in connection with one particular embodiment, the present disclosure is not limited to the embodiment. Various modifications, combinations and alterations may occur insofar as they are within the scope of the appended claims or the equivalents thereof. For example, the first movable joining portions 32 and the second movable joining portions 33 are formed in a spherical shape in the embodiment described above. However, they may be made from an elastic material such as rubber.

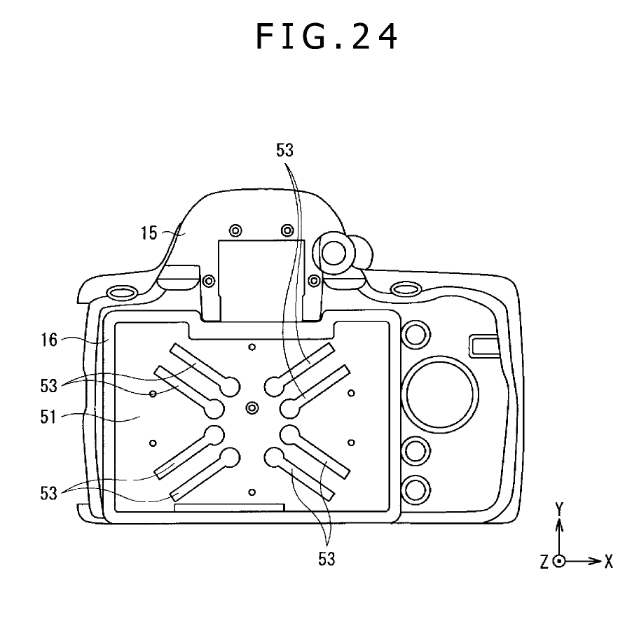

Further, although four arms 30 are provided in the embodiment described above, the number of the arms 30 may be equal to a multiple of four, such as four, eight or twelve. For example, when eight arms 30 are provided, it is possible to provide eight guide slots 53 radially, two slots in each of the four directions as seen in FIG. 24.

Further, in the embodiment described above, the first movable joining portions 32 are attached to the display section 20 while the second movable joining portions 33 are attached to the main body section 2 so as to allow changing of the inclination angle of the arms 30 with respect to the main body section 2. It is also possible to attach the first movable joining portions 32 to the main body section 2 and attach the second movable joining portions 33 to the display section 20 so as to allow changing of the inclination angle of the arms 30 with respect to the display section 20. However, the former configuration is advantageous in that the display section 20 can have a reduced thickness and weight, which allows the user to more easily hold and move the display section 20 with his or her hand.

As another example, in the embodiment described above, the display section 20 and the accommodating section 16 have a rectangular shape and the arms 30 are provided radially on the diagonal lines of the display section 20 and the accommodating section 16. However, the display section 20 and the accommodating section 16 may not have a rectangular shape but a polygonal shape such as a hexagonal shape or a circular shape. As another example, in the figures, quadrangular cut-off portions are provided at the corners at the opposite ends of the lower side of the display section 20, but those cut-off portions may not be provided.

As another example, in the embodiment described above, the first specific position P1 of the display section 20 is at the center of the display section 20 and the second specific positions P2 of the accommodating section 16 are at the four corners of the accommodating section 16. However, the first specific position P1 and the second specific positions P2 may be placed at positions different from those described above. For example, it is possible to place the first specific position P1 of the display section 20 at the four corners of the display section 20 and place the second specific positions P2 of the accommodating section 16 at the center of the accommodating section 16. In this case, the first movable joining portions 32 may be distributed to the four corners of the display section 20, so that the second movable joining portions 33 can radially move in the xy plane along the diagonal lines of the accommodating section 16 from the second specific position P2 at the center of the accommodating section 16 of the main body section 2 to the four corners of the accommodating section 16.

As another example, in the embodiment described above, a digital single lens reflex camera is described as an example of the image pickup apparatus 1. However, the present disclosure can also be applied to other image pickup apparatus such as a compact camera and a video camera.

As another example, in the embodiment described above, the display section 20 is configured from a liquid crystal display element. However, the display section 20 may be one that does not use a liquid crystal display element but other display element such as a display element of plasma, organic EL (Electroluminescence), inorganic EL, electro deposition or electro chromic.

Further, an application of the display apparatus 3 of the present disclosure is not limited to a liquid crystal monitor of the image pickup apparatus 1. It may also be applied to other display apparatus such as a wall-mounted television apparatus, wall-mounted monitor apparatus, portable telephone, telephone set, facsimile apparatus, car navigation apparatus, digital photo frame or electric bulletin board.

The present technology may also take the following configurations.

(1)

A display apparatus, including: a display section; and arms connecting the display section with an attachment target to which the display section is to be attached in such a manner that inclination angles of the arms with respect to the display section or the attachment target can be changed independently of each other, the number of the arms being a multiple of four.

(2)

The display apparatus according to (1), wherein each of the arms has a stem portion, and a first movable joining portion and a second movable joining portion at the opposite ends of the stem portion, and the first movable joining portion is attached to one of the display section and the attachment target in a rotatable manner, while the second movable joining portion is attached to the other one of the display section and the attachment target such that it can move in-plane.

(3)

The display apparatus according to (2), wherein the first movable joining portion and the second movable joining portion have a spherical shape.

(4)

The display apparatus according to (2) or (3), wherein the first movable joining portion is disposed at a first specific position on the one of the display section and the attachment target, and the second movable joining portion can move in-plane in a radial direction from a second specific position on the other one of the display second and the attachment target.

(5)

The display apparatus according to (4), wherein the second movable joining portion is sandwiched between a pair of plates fixed to the other one of the display section and the attachment target, and the second movable joining portion can move in-plane along a guide slot formed in the plates.

(6)

The display apparatus according to (5), wherein the pair of plates are fixed to each other by a screw with a spacer interposed therebetween, and a rubber washer is provided between a seat of the screw and one of the pair of plates.

(7)

The display apparatus according to any one of (2) to (6), further including an arm holder fixed to the one of the display section and the attachment target, the arm holder having a holder configured to accommodate the first movable joining portions in a rotatable manner.

The present disclosure contains subject matter related to that disclosed in Japanese Priority Patent Application JP 2011-229170 filed in the Japan Patent Office on Oct. 18, 2011, the entire content of which is hereby incorporated by reference.

What is claimed is:

1. A display apparatus, comprising:
a display section; and
arms connecting said display section with an attachment target to which said display section is to be attached in such a manner that inclination angles of said arms with respect to said display section or the attachment target can be changed independently of each other, the number of said arms being a multiple of four.

2. The display apparatus according to claim 1, wherein each of said arms has a stem portion, and a first movable joining portion and a second movable joining portion at the opposite ends of said stem portion, and
said first movable joining portion is attached to one of said display section and the attachment target in a rotatable manner, while said second movable joining portion is attached to the other one of said display section and the attachment target such that it can move in-plane.

3. The display apparatus according to claim 2, wherein said first movable joining portion and said second movable joining portion have a spherical shape.

4. The display apparatus according to claim 2, wherein said first movable joining portion is disposed at a first specific position on the one of said display section and the attachment target, and
said second movable joining portion can move in-plane in a radial direction from a second specific position on the other one of said display second and the attachment target.

5. The display apparatus according to claim 4, wherein said second movable joining portion is sandwiched between a pair of plates fixed to the other one of said display section and the attachment target, and said second movable joining portion can move in-plane along a guide slot formed in the plates.

6. The display apparatus according to claim 5, wherein the pair of plates are fixed to each other by a screw with a spacer interposed therebetween, and a rubber washer is provided between a seat of the screw and one of the pair of plates.

7. The display apparatus according to claim 2, further comprising an arm holder fixed to the one of said display section and the attachment target, said arm holder having a holder configured to accommodate said first movable joining portion in a rotatable manner.
